(19) United States
(12) Patent Application Publication
(10) Pub. No.: US 2019/0214780 A1
(43) Pub. Date: Jul. 11, 2019

(54) SELF-ADJUSTING CRIMPING TOOL

(71) Applicant: Pressmaster AB, Älvdalen (SE)

(72) Inventor: Daniel ULLBORS, Mora (SE)

(73) Assignee: Pressmaster AB, Älvdalen (SE)

(21) Appl. No.: 16/305,001

(22) PCT Filed: Jun. 12, 2017
(86) PCT No.: PCT/SE2017/050625

§ 371 Date: Nov. 27, 2018

(30) Foreign Application Priority Data
Jun. 10, 2016 (SE) 1650821-0

(51) Int. Cl. H01R 43/042; H01R 43/058; B25B 27/14

(52) U.S. Cl. CPC H01R 43/042; B25B 27/146; H01R 43/058

(57) ABSTRACT

A crimping tool is disclosed for crimping items to a substantially ellipsoidal shape. The crimping tool includes a first and a second die arranged to interact with each other, each including a circular segment surface, wherein the dies are arranged such that the circular segments are opposed to each other forming a substantially ellipsoidal shape between them. The first die is pivotally arranged to move in a part circular movement with respect to the second die, substantially without rotating around its own center, wherein the circular segment of the first die at a trailing end thereof includes an edge arranged to follow the circular segment surface of the second die, thereby continuously closing a first end of the substantially ellipsoidal shape between the circular segments.

### TECHNICAL FIELD

The invention relates to a self-adjusting crimping tool for crimping items of different sizes. The crimping tool may be a hand tool or a powered tool, e.g. a hydraulically, pneumatically or electrically powered tool.

### BACKGROUND

Crimping tools are used for cable termination and may be hand tools or powered tools, e.g. hydraulically powered tools. Cable termination is required e.g. for connecting a cable or a wire to power, coaxial, fibre-optic or modular connectors. The crimping tool provides a clamping force that mechanically clamps a connector to an end portion of a cable. Hence, when crimping, a connector i.e. a terminal, splice, contact or a similar device is mechanically secured to a cable—e.g. to a conductor such as a wire—by deformation so that a solid joint having reliable mechanical and electrical connection is formed. The crimping operation resulting in a crimped joint is e.g. performed using crimping dies.

Different connectors have different shapes and different sizes. Therefore, the tool heads of crimping tools are typically specifically adapted to a specific connector shape and may e.g. be polygonal, circular or oval. Further, the tool head needs to be adapted to a specific size. Conventionally, a tool head has not been adapted to crimp connectors of different sizes. Instead, multiple dies or dies with multiple crimping positions have been used.

In US 2015/349478 a crimping tool is disclosed, in which crimping dies are co-operating so as to crimp an item into a rectangular, specifically quadratic, cross section. The co-operating dies of the crimping tool are advantageous in that they accept different sizes of the same cross sectional shape. The technique may also be implemented on other polygonal shapes, such as e.g. hexagonal or triangular, by arranging a corresponding number of dies on the tool head. It is however not adapted to handle other shapes than polygonal shapes.

Crimping tools for crimping non-polygonal shapes such as oval shapes or the like are generally not adapted for items of different sizes. Normally such tools comprise several positions, each designed for the crimping of an item of a specific size. There is not one position that is adapted to crimp oval shapes of different sizes.

Hence, there is a need of a crimping tool that facilitates crimping of non-polygonal shapes, such as oval shapes.

### SUMMARY OF THE INVENTION

It is an object of the present invention to provide a crimping tool that facilitates crimping of non-polygonal shapes, such as oval shapes.

The invention relates to a crimping tool for crimping items to a substantially ellipsoidal shape, the crimping tool comprising a first and a second die arranged to interact with each other, each comprising a circular segment surface, wherein the dies are arranged such that the circular segments are opposed each other forming a substantially ellipsoidal shape between them, characterised in that the first and the second interacting dies are movable with respect to each other, the first die being pivotally arranged to move in a part circular movement with respect to the second die, substantially without rotating around its own centre, wherein the circular segment of the first die at a trailing end thereof comprises an edge arranged to follow the circular segment surface of the second die, thereby continuously closing a first end of the substantially ellipsoidal shape between the circular segments.

In accordance with specific embodiment if the invention the second die comprises an edge arranged to follow the circular segment surface of the first die, thereby continuously closing a second end of the substantially ellipsoidal shape between the circular segments.

In another specific embodiment the second die is fixed on the crimping tool and the first die is pivotally arranged in two, or more, pivot arms of an equal pivot length.

In yet another specific embodiment the circular segment surfaces of both the first and second die have a radius of curvature that correspond to a circle with radiuses equalling the pivot length of the two pivot arms.

The crimping tool may be a hand tool or a powered tool, e.g. a hydraulically, pneumatically or electrically powered tool.

Other embodiments and advantages will be apparent from the detailed description and the appended drawings.

### BRIEF DESCRIPTION OF DRAWINGS

An exemplary embodiment related to the invention will now be described with reference to the appended drawings, in which;

FIG. 1-3 are schematic views of the crimping dies in a crimping movement from an open position in FIG. 1 to an almost closed position in FIG. 3;

FIG. 4 shows the dies of the crimping tool positioned in a first end position;

FIG. 5 shows the dies of the crimping tool positioned in a second end position; and

FIG. 6 illustrate various geometric proportions of the crimping tool, with the dies positioned in the first end position.

### DETAILED DESCRIPTION OF EMBODIMENTS

In FIGS. 1-3 a crimping tool 10 for crimping items, such as connectors to a wire end, into a substantially ellipsoidal shape in three different states. The crimping tool 10 may be a hand tool or a powered tool, e.g. a hydraulically, pneumatically or electrically powered tool. Below the interaction between the two dies 11 and 12 of the crimping tool is described. This interaction is independent of whether the tool is a hand tool or a powered tool. It is obvious to a person skilled in the art how to provide linked arms for implementing the dies in a hand tool or how to provide a motor arrangement for implementing the dies in a powered tool.

The crimping tool 10 comprises a tool head 20 carrying a first die 11 and a second die 21 arranged to interact with each other. Each die 11,21 comprises a circular segment surface 12,22 and the dies are arranged such that the circular segments 12,22 are opposed each other forming a substantially ellipsoidal shape E₁₋₃ between them. The first and the second interacting dies 11,21 are movable with respect to each other. In the shown embodiment the first die 11 is pivotally arranged to move in a part circular movement with respect to the second die 12, substantially without rotating around its own centre. The first die 11 is moved by providing a force F in a closing direction as illustrated in FIG. 1. Preferably, the first die 11 is biased in the opposite direction so as to, after a concluded crimping operation, return the first die 11 to an initial open position, ready for a subsequent crimping operation.

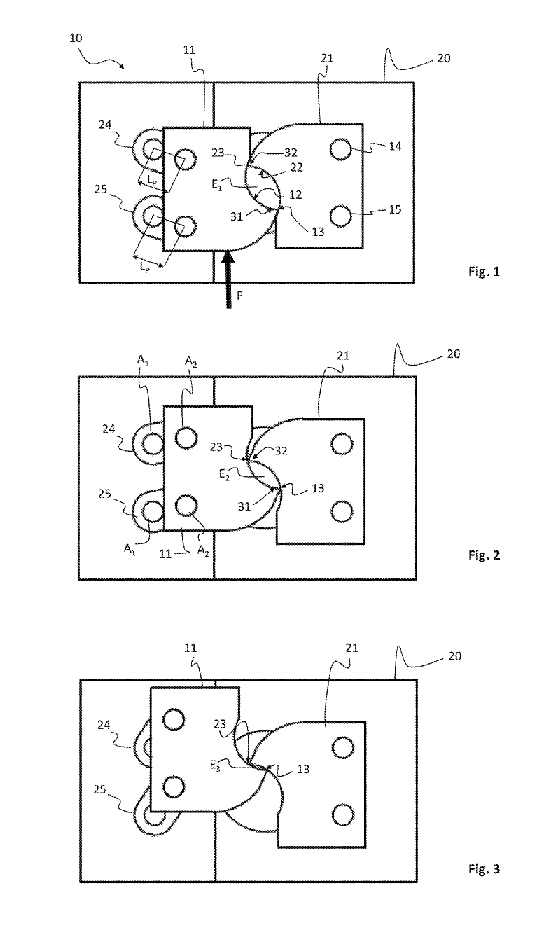

In the shown embodiment the second die 21 is fixed with respect to the tool head 20 of the crimping tool 10, wherein the first die 11 is pivotally arranged in two pivot arms 24,25 of an equal pivot length L_{P} (see FIG. 1). As illustrated in FIG. 2 both arms are pivotally arranged to the tool head 20 in fixed pivot points A₁, wherein the first die 11 is attached to the pivot arms 24,25 in movable pivot pints A₂. The pivot length L_{P} is here intended to be construed as the distance R1 between a movable pivot point A₂ of a pivot arm and a fixed pivot point A₁ of the same pivot arm. This arrangement of two pivot arms 24,25 of equal length makes sure that the first die 11 will not rotate around its centre. Instead its trajectory will describe a part of a circle with a radius of curvature corresponding to the pivot length L_{P} of the pivot arms. The die may also be arranged in more than two pivot arms or in only one pivot arm complemented by an arrangement for limiting rotation of the first die around its own centre. The second die 21 is fixed to the tool head 20, e.g. by fasteners 14 and 15.

The circular segment 12 of the first die 11 comprises an edge 13, which constitutes a first end 31, a trailing end, of the circular segment 12 with respect to its circular movement and which is arranged to follow the circular segment surface 22 of the second die 21 closely, thereby continuously closing a first end of the substantially ellipsoidal shape E₁₋₃ between the circular segments 12,22. The first end 31 of the substantially ellipsoidal shape is hence defined by the interaction of the edge 13 of the of the first die 11 and the circular segment surface 22 of the second die 21.

Likewise, the circular segment 22 of the second die 21 comprises an edge 23, which constitutes a distal, second end of the circular segment 22 with respect to the circular movement of the first die 11 and which is arranged to closely follow the circular segment surface 12 of the first die 11 as it progresses in its circular movement, thereby continuously closing the second end 32 of the substantially ellipsoidal shape between the circular segments 12,22. The second end is hence formed between the edge 23 of the of the second die 21 and the circular segment 12 of the first die 11.

A crimping operation is performed in that one or more item to be crimped, e.g. a connector and wire end onto which the connector should be crimped, are positioned in the substantially ellipsoidal shape E₁ between the circular segments 12,22 when it is in an open position, i.e. as shown in FIG. 1. Once the item(s) have been positioned the first die 11 is set to move in its circular trajectory whereby the substantially ellipsoidal shape E₁ between the circular segments 12,22 continuously decreases in size via the medium sized ellipsoidal shape E₂ in FIG. 2, to the very small ellipsoidal shape E₃ in FIG. 3. The crimping operation is typically driven until a predetermined force, corresponding to a target crimping force, is accomplished. Hence, the crimping operation may be concluded at any position between the ellipsoidal shape E₁ as shown in FIG. 1 and the ellipsoidal shape E₃ as shown in FIG. 3 depending on the size and hardness of the item(s) to be crimped. Preferably, the first die 11 is biased, e.g. by means of a spring, towards an open position as illustrated in FIG. 1.

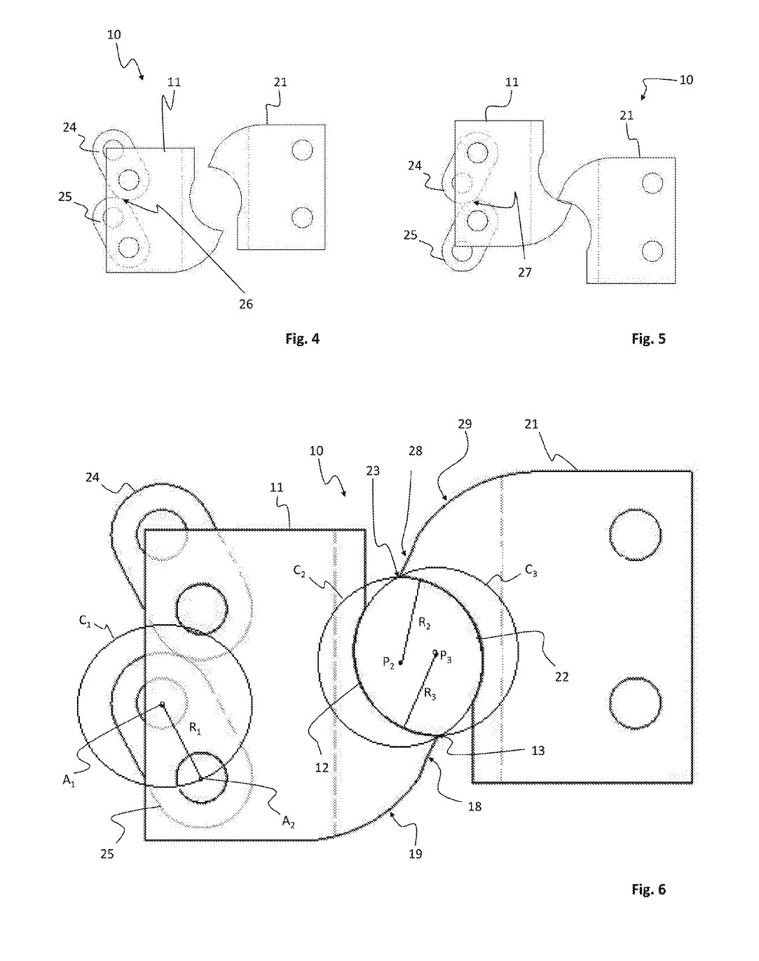

As is illustrated in FIGS. 4 and 5 the circular movement is preferably limited such that the first die 11 may only rotate a part of circular movement. In FIG. 4 a first end position is shown, in which the opening between two dies is as large as it gets. In the shown embodiment the dies 11,21 are allowed to move out of contact with each other in order to maximize the area between the dies 11,21. This is of course easily adapted by a person skilled in the art and a stop may be arranged in any desired position or, if so desired, no stop is arranged such that the first die is free rotate a full lap. Further, only one stop may be arranged to so as to stop the first die 11 from completely passing second die 21, i.e. to stop the edge 13 of the of the first die 11 before or when it passes the edge 23 of the second die 21. In the shown embodiment the stop action is provided in that the two pivot arms 24, 25 are located so as to interact with each other.

Hence, in both extreme positions as shown in FIGS. 4 and 5 the pivot arms 24 and 25 are in hindering contact with each other, such that they are prevented from further rotation in one direction. In FIG. 4 the outer end of the first pivot arm 24 abuts the inner end of the second pivot arm 25 in a rest position 26, and in FIG. 5 the outer end of the second pivot arm 25 abuts the inner end of the first pivot arm 24 in a rest position 27. The point at which further rotation should be prevented may be adjusted by adjusting the distance between the pivot arms 24 and 25, and/or by using pivot arms of different width. Interaction between the pivot arms 24,25 may be avoided if the pivot arms are positioned at a distance from each other that exceeds the full length of the pivot arms 24 and 25, i.e. the length between the outermost parts of the pivot arms 24 and 25. With such an arrangement the die could be rotated a full lap or another stop action, independent of the pivot arms, may be provided.

FIG. 6 is an enlargement of the crimping tool 10 in the position of FIG. 4. Three circles C₁-C₃ have been drawn in the figure to illustrate the geometrical proportions of the tool's features. The first circle C₁ illustrates the imagined trajectory of the movable pivot point A₂ of the second pivot arm 25 around the fixed pivot point A₁ of said second pivot arm 25. The radius R₁ of the first circle C₁ thus equals the pivot length L_{P} of the pivot arms 24 and 25 as illustrated in FIG. 1. The imagined trajectory of the movable pivot point of the first pivot arm 24 around the fixed pivot point of said first pivot arm 24 would thus have the same radius and is not illustrated in FIG. 6.

The second circle C₂ has a radius R₂ and illustrates the imagined trajectory of the edge 13 of the first die 11 around an imaginary centre point P₂. The second circle C₂ coincide with the circular segment 22 of the second die 21. Hence, in addition to showing the trajectory of the edge point 13 the second circle C₂ also illustrates a full circle corresponding to the circular segment 22 of the second die 21. This is natural since the edge 13 of the first die 11 is adapted to follow said circular segment 22 with as little play as possible.

The third circle C₃ illustrates a full circle corresponding to the circular segment 12 of the first die 11. The third circle C₃ has an imaginary centre point P₃ and a radius R₃. Since the first die 11 is moving in a part circular movement the circular segment 12 will move along with it, and so will the illustrative third circle C₃. However, in correspondence to the fact that the edge 13 of the first die 11 follows the second circle C₂, a part of the third circle C₃ will always coincide with the edge 23 of the of the second die 21, and said edge 23 will hence follow the circular segment 12 of the first die 11 with as little play as possible as the first die 11 circles along its trajectory.

The edge 13 of the first die 11 is the outermost part of the circular segment 12 of the first die 11, and correspondingly the edge 23 of the second die 21 is the outermost part of the circular segment 22 of the second die 21. Hence, the circular segments 12 and 22 are asymmetric with respect to opposed faces of the dies 11 and 21, the edges 13,23 hence being the respective outermost part of each die 11,21.

It is to be noted that the circles C₁, C₂ and C₃ are of the same size and thus have the same radiuses, i.e. R₁=R₂=R₃. In other words: the circular segment surfaces 12,22 of both the first and second die 11,21 have a radius of curvature that correspond to a circle with a radius equalling the pivot length L_{P} of the two pivot arms 24 and 25. Further, as is apparent from above and from the figures the dies are so positioned with respect to each other so that the edge 13 of the first die 11 is adapted to follow the circular segment 22 of the second die 21 with as little play as possible and so that the edge 23 of the second die 21 will follow the circular segment 12 of the first die 11 with as little play as possible, as the first die 11 circles along its trajectory.

As is apparent from FIG. 6 the both dies 11,21 are preferably provided with concave portions 18 and 28, respectively, at the trailing end of the edges 13 and 23, respectively. These concave portions 18 and 28 are arranged to make sure that trailing end of the edges 13 and 23, respectively, are not interfering with the circular segments 22,12, respectively, of the opposite die 11,21. Outside the respective concave portions convex portions 19, 29 adjoin the front ends of the dies 11,21 with the side portions. To facilitate machining of the dies all machined surfaces, including the circular segments 12,22, the concave portions 18 and 28, and the convex portions 19, 29 may have constant radiuses. Hence for each portion the radius is constant. The different portions do however not need to have the radius.

Above, the invention has been described with reference to a specific embodiment. It is obvious to a person skilled in the art that other embodiments are possible within the scope of the following claims.

1. A crimping tool for crimping items to a substantially ellipsoidal shape, the crimping tool comprising a first and a second die arranged to interact with each other, each comprising a circular segment surface, wherein the dies are arranged such that the circular segments are opposed each other forming a substantially ellipsoidal shape between them, characterized in that the first and the second interacting dies are movable with respect to each other, the first die being pivotally arranged to move in a part circular movement with respect to the second die, substantially without rotating around its own center, wherein the circular segment of the first die at a trailing end thereof comprises an edge arranged to follow the circular segment surface of the second die, thereby continuously closing a first end of the substantially ellipsoidal shape between the circular segments.

2. The crimping tool according to claim 1, wherein the second die comprises an edge arranged to follow the circular segment surface of the first die, thereby continuously closing a second end of the substantially ellipsoidal shape between the circular segments.

3. The crimping tool according to claim 1, wherein the second die is fixed on the crimping tool and the first die is pivotally arranged in two pivot arms of an equal pivot length.

4. The crimping tool according to claim 3, wherein the circular segment surfaces of both the first and second die have a radius of curvature that correspond to a circle with radiuses equalling the pivot length of the two pivot arms.

5. The crimping tool according to claim 1, wherein the crimping tool is a hand held tool, two pivoted handles being arranged to provide a mutual movement of the dies.

6. The crimping tool according to claim 1, wherein the crimping tool is a powered tool, a motor being arranged to provide a mutual movement of the dies.
